(19) United States
(12) Patent Application Publication
(10) Pub. No.: US 2002/0073772 A1
(43) Pub. Date: Jun. 20, 2002

(54) Liquid flow sensor

(76) Inventors: Ulrich Bonne, Hopkins, MN (US); Werner Hugger, Hassmersheim (DE)

Correspondence Address: HONEYWELL INTERNATIONAL INC., 101 COLUMBIA ROAD, P O BOX 2245, MORRISTOWN, NJ, 07962-2245, US

(21) Appl. No.: 09/741,914

(22) Filed: Dec. 20, 2000

(51) Int. Cl. G01F 1/68

(52) U.S. Cl. 73/204.11

(57) ABSTRACT

A liquid flow microsensor having a flow tube with a sensor aperture on the surface and having a straight-through conduit for fluid flow. A sensor assembly is mounted within the sensor aperture, and includes a thermal sensor positioned to be within the straight-through conduit in direct communication with the fluid flow so as to sense thermal characteristics representative of a fluid flow rate.

### BACKGROUND OF THE INVENTION

The invention relates to fluid sensors and, particularly, to fluid (i.e., gas or liquid) flow thermal microsensors.

Many liquid flow sensors claim to offer reliable service, cover a wide flow range, be low-cost, compact, temperature-independent and fast. However, few combine such qualities. Typically liquid flow is measured by measuring the change in pressure across an orifice or venturi nozzle. Unfortunately, such liquid flow sensors based on pressure differential measurements have a flow range that is limited by the extremely high pressure range requirements inherent in such systems. Such pressure sensors are also called delta-p sensors herein.

Other types of flow sensors have used a thermistor as a sensor in a package having thick film on ceramic. Thermistor sensors typically have surface dimensions of about 0.5-2 mm in diameter. As a result, they require a relatively large amount of power.

Another example of a flow sensor is found in U.S. Pat. No. 6,079,253 to Bonne, et al. entitled “Method and Apparatus for Measuring Selected Properties of a Fluid of Interest Using a Single Heater Element,” issued Jun. 27, 2000. Bonne et al. '253 discloses a method and apparatus for determining selected fluid properties including thermal conductivity, pressure and/or temperature using a single heater element of the sensor, and in a relatively short period of time. This is accomplished by measuring a variable phase or time lag between an input signal provided to the heater element and a subsequent transient temperature response of the heater element. Unlike the present invention, the signal sensor of the '253 patent is based on a transient response. U.S. Pat. No. 6,079,253 is incorporated herein by reference.

### SUMMARY OF THE INVENTION

The present invention provides a liquid flow sensor comprising a flow tube having a sensor aperture on the surface and having a straight-through conduit for fluid flow. A sensor assembly is mounted within the sensor aperture, wherein the sensor assembly includes a thermal sensor positioned to be within the straight-through conduit in direct communication with said fluid flow so as to sense thermal characteristics representative of a fluid flow rate.

It is one object of the present invention to provide a straight-through liquid flow sensor based on a rugged, thermal flow sensor chip having the trade name Microbrick™.

It is another object of the present invention to provide a liquid flow sensor that meets response time specifications below 1 second, requires minimal flow straightening, covers the wide flow range indicated in FIG. 2, and costs less than currently available sensors having comparable characteristics.

One advantage of the liquid sensor of the invention over previous approaches is that the invention provides a liquid flow sensor that uses effective honeycomb flow straighteners, and direct, rather than bypass, mounting of the flow sensor to substantially eliminate plugging of a narrow bypass flow channel.

Another advantage of the liquid sensor of the invention is that it provides a liquid flow sensor that has a wider flow range of operation than pressure differential (delta-p) thermal approaches, and shorter response times than larger and massive ceramic-based thermal flow sensors.

### BRIEF DESCRIPTION OF THE DRAWINGS

FIG. 1 schematically shows an exemplary liquid flow sensor constructed in accordance with the present invention in cross-section view.

FIG. 2 shows plotted data of microbridge sensor output versus standard flow rate for one example of the present invention.

FIGS. 3A through 3G illustrate various sensor microstructures as may be employed in a liquid flow sensor of the invention.

FIG. 4 shows a schematic view of honeycomb flow straighteners or screens used in one example of the liquid flow sensor of the present invention.

FIG. 5 shows a schematic view of alternative flow straighteners or screens used in another example of the liquid flow sensor of the present invention.

### DETAILED DESCRIPTION OF THE PREFERRED EMBODIMENT

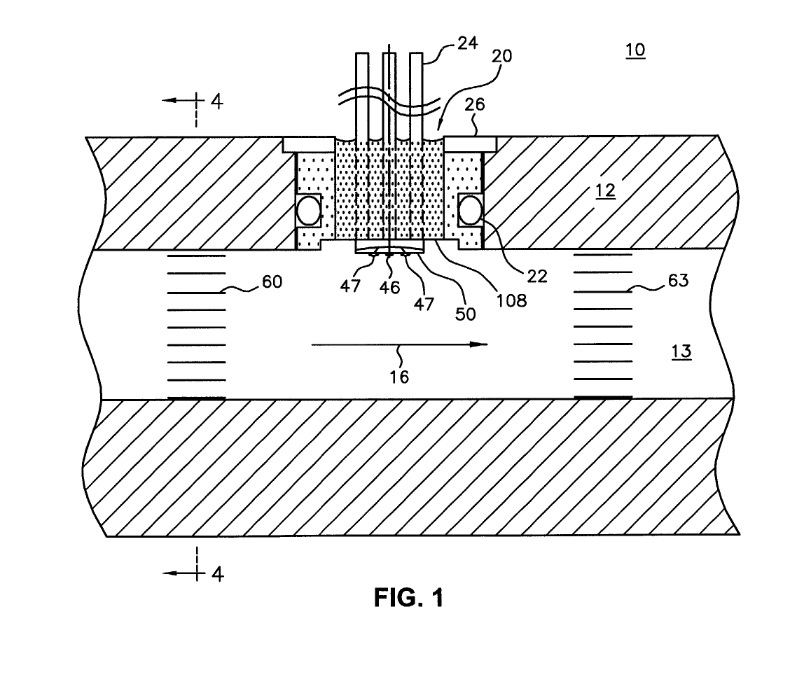

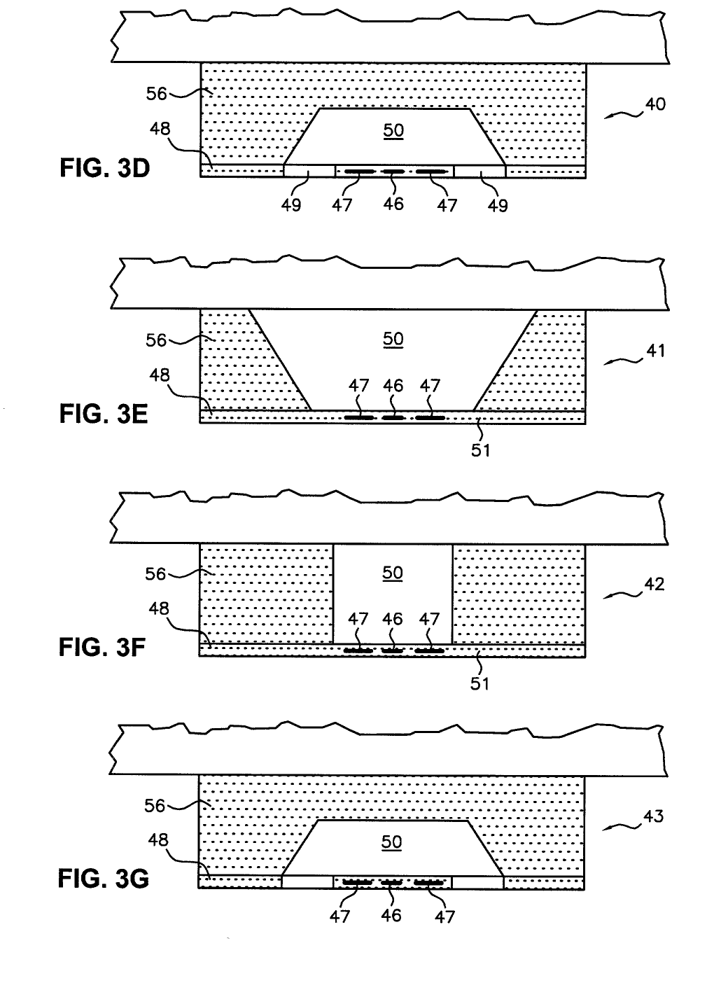

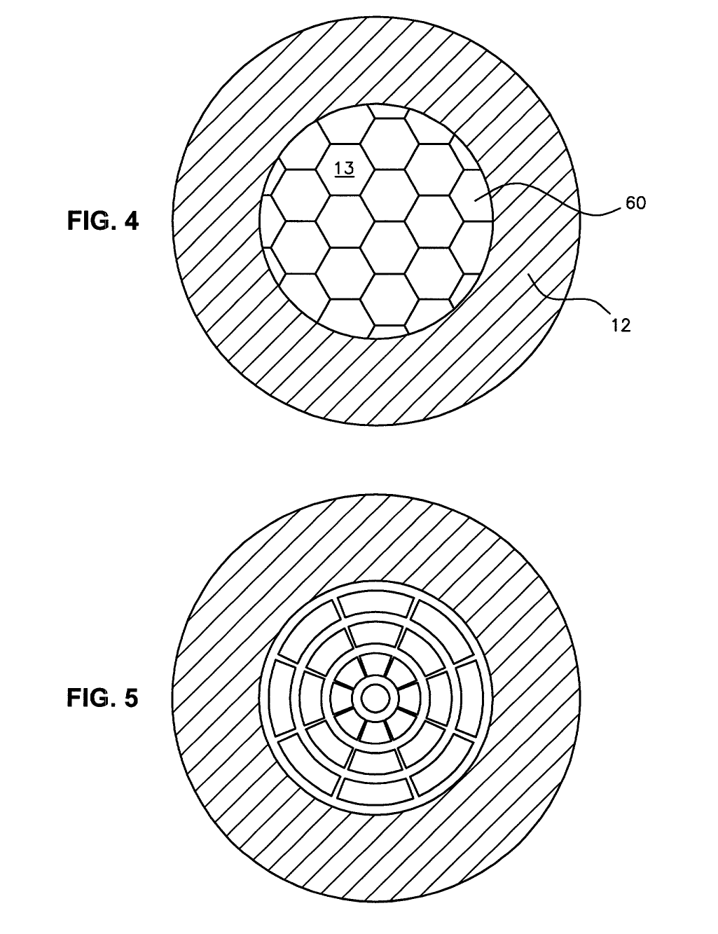

In order to promote understanding of the invention, it is described herein with reference to example embodiments. It will be understood that the invention is not limited by the illustrative examples. FIG. 1 schematically shows an exemplary liquid flow sensor 10 constructed in accordance with the present invention in cross-section view. The flow sensor 10 comprises a thermal sensor assembly 20 mounted in flow-tube 12. The exemplary flow sensor assembly 20 comprises a TO-18 style package having posts 24, mounting flange 26 and O-ring seal 22. The posts 22 are embedded in a substrate 108. A thermal sensor 50, preferably comprising a Microbrick™ sensor, is deposited on or otherwise mounted on the substrate 108. Honeycomb screens 60 and 63 are contained within a conduit 13 of the flow tube 12. Honeycomb screen 60 faces flow direction indicated by arrow 16 to calm down turbulence. FIG. 4 shows an example of a honeycomb design of the screen 60. Screen 63 may advantageously be substantially similarly constructed. FIG. 5 shows an alternative screen structure. Such screen structures may comprise aluminum, plastic or equivalent materials.

In one example embodiment constructed by Honeywell Inc. of Minneapolis, Minn., USA, an exemplary sensor was built and mounted on a 15-mm ID Delrin® polymer flow tube. Delrin® is a synthetic resinous plastic material manufactured by E. I. Du Pont De Nemours and Company Corporation, 1007 Market St., Wilmington, Del. Honeycomb screens having a 3 mm cell size were fastened upstream and downstream of the sensor chip, to straighten the flow. Other materials suitable for use in constructing the flow tube include polymeric materials, nylon, polyimide, and equivalents thereof.

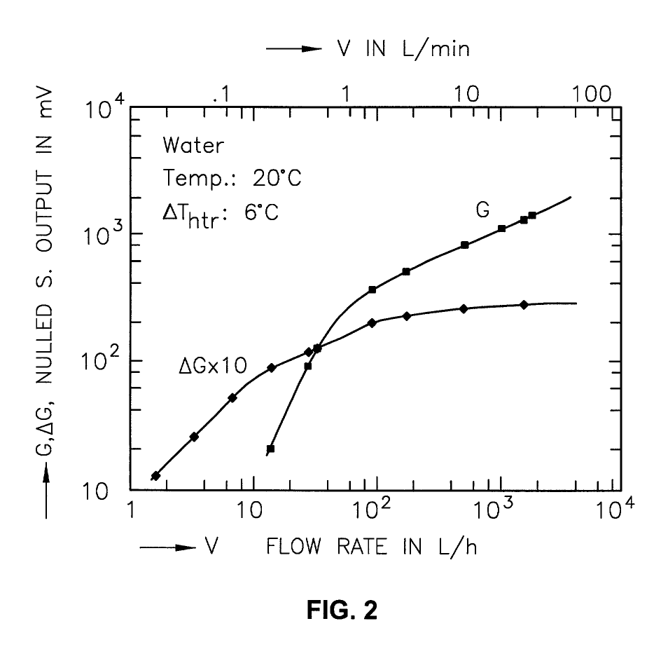

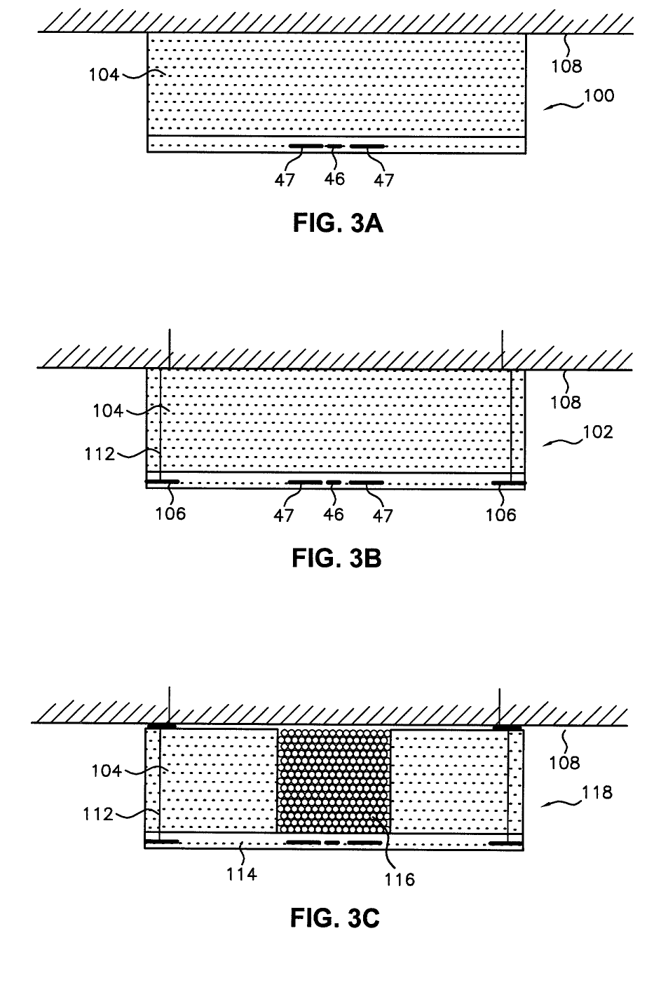

Referring now to FIG. 2 plotted data of microbridge sensor output versus standard flow rate for one example of the present invention is shown. The sensor used was a Microbrick™ thermal sensor chip, as described in detail below with respect to FIGS. 3A-3C. Both heater control voltage factor G, and differential sensor output, [symbol] G were recorded, and then plotted in FIG. 2. Heater control voltage factor G is a direct measurement of the sensor signal. Differential sensor output, [symbol] G, is a differential value derived from comparing signals from upstream and downstream non-energized sensing elements flanking the central heating element, all of which are more or less influenced by forced convection. The sensing elements may be, for example, Pt thin-film resistors or the like.

The vertical axis represents G and [symbol] G, as the case may be, as output in millivolts. The bottom horizontal axis represents volume flow, V, in liters per hour. The upper horizontal axis represents volume flow, V, in liters per minute. The measurements were taken with a water temperature of 20° C.

### Microsensor Technology

The present invention employs micromachined thermal flow sensors, i.e. thermal microanemometers, that, comprise either:

a. Front-etched microbridge sensor chips of ˜1.7×1.7 mm, with bridges of ˜0.2×0.25 mm, for sensing gaseous fluid flows, or

b. Very rugged, Microbrick™ sensor chips of equal size but without etched cavities, for sensing liquid fluid flows. A Microbrick™ sensor is burst-proof and designed for operation in harsh environments featuring gas or liquid mass fluxes to 500 g/cm2/s, with condensable vapors and suspended particles.

In experiments done by Honeywell Inc. such thermal flow sensors themselves showed the capability to operate at frequencies above 500 Hz, especially the rugged version, which showed response times down to ˜0.2 ms.

Useful thermal flow microsensors used in part of this work, and their fabrication and performance have been described in earlier publications, namely,

1. R. Higashi, R. G. Johnson, A. K. Mathur, A. N. Pearman and U. Bonne, “Microstructure Sensors for Flow, DifferentialPressure and Energy Measurement,” IGT Symposium on Natural Gas Energy Measurement, Chicago, Ill., Apr. 30-May 2, 1986, Proceedings.

2. U. Bonne, “Fully Compensated Flow Microsensor for Electronic Gas Metering,” Intl. Gas Research Conference, Orlando, Fla., Nov. 16-19, 1992, Proceedings, Vol.III p.859

3. U. Bonne, “Sensing Fuel Properties with Thermal Microsensors,” SPIE Smart Electronics and MEMS Conference, San Diego, Calif., Feb. 25-29, 1996, Paper No. 2722-24, Proceedings p.165

4. R. Frampton, J. Walleshauser, U. Bonne, D. Kubisiak, D. Hoy, I. Andu and K. Kelly, “Gas Mass Flow Sensor Proof of Concept Testing for Space Shuttle Orbiter Flow Measurement,” 26th Int'l. Conf. Env.Systems, Monterey, Calif., Jul. 8-11, 1996, SAE Tech.Paper 961335.

By way of a brief recap, thermal flow microsensors have structures consisting of thin, micromachined bridges, that provide thermal isolation and support the heating and sensing elements as illustrated by the chip cross sections of, for example, FIGS. 3A-3G. A typical structure may be about a 1 mm-thick sandwich of silicon nitride around ˜0.05-0.1Πm-thick platinum thin-film sensing elements. Such sensor chips offer large dynamic flow range (e.g. ˜3,000:1), short response time (e.g. ˜1 ms), low-power (e.g. 0.1-10 mW), compactness (e.g. having a volume ≦2×2×0.5 mm), chip-to-chip interchangeability within 5%, wide temperature range (e.g. −60 to 160° C.), good stability (e.g. drift <50 ppm after dozens of −20 to 120° C. thermal cycles), and low manufacturing cost (e.g. ˜$1), but with due limitations imposed by packaging materials and electronics. The same sensor chips are also used for direct measurement of thermal transport properties: thermal conductivity, specific heat, thermal diffusivity; and for correlations with “higher value” (gas or liquid) fuel properties such as heating value, oxygen demand, octane and cetane numbers. The aforementioned values were obtained under relatively mild operating environments.

The present invention, for the first time provides a mechanism for using such high-performance sensors for straight-through flow and property measurements in applications involving harsh environments such as condensing vapors or liquids, high-mass-flux process streams and those carrying dust particles. For example, condensates collected under microbridge microspaces are extremely hard to remove even by raising the microheater temperature by an extra 80° C. Moderate mass flux conditions in either gases or liquids (>5 g/cm2/s), especially when associated with entrained “dust” (sand or rust particles of up to 0.3 mm diameter), have destroyed microbridge sensors, so that reliable operation in industrial applications with gas or water mass fluxes of up to 80 or 500 g/cm2/s, respectively, would have been short-lived.

At flows up to ˜1 m/s, the microbridge sensor flow response time decreases to 0.8 ms, but the value for the more rugged Microbrick™ sensor drops to 0.3 ms, or lower still at higher flows. Conservatively, this means that Microbrick™ sensors can be operated in oscillatory flows at frequencies of up to ˜200 Hz and 530 Hz, respectively.

FIGS. 3A, 3B and 3C illustrate various rugged Microbrick™ type sensor microstructures as may be employed in a liquid flow sensor of the invention. FIG. 3A shows a ruggedized sensor structure 100, whereby the semiconductor body of the sensor comprises an electrically and thermally insulating material 104 such as ceramic, metal oxide, or glass. Pyrex is a preferred glass because it has a matching thermal coefficient of expansion (TCE) to that of silicon. According to the structure 100, the heaters 47 and sensing elements 46 are deposited on the bulk insulating material 104.

In a related structure 102 of FIG. 3B, and in order to increase the sensor's ruggedness a further step, the traditional external (and therefore breakable) wire contacts have been replaced by conducting paths through and internal to the above insulating material 104 and directly to the substrate 108 of the sensor structure.

A structure 118 of greater sensitivity, featuring a sensing membrane 114 supported by a solid, TCE-matched, porous, low thermal conductivity structure 116 is shown in FIG. 3C. The low thermal conductivity structure may be comprised of high density lead oxide glass, porous materials such as silica gels, metal oxides and zeolites, or composite materials such as glass frits. Sensor structure 118 may also include internal conducting paths 112 through the insulating material 104 to insulator 108. The contacts may comprise front-wire bonds (FWB) or through-the-wafer (TTW) contacts. The latter offer better electrical isolation or passivation to enable sensing in contact with electrically conductive liquids, like water.

An alternative embodiment for sensor chip design is presented, for example, in FIG. 3G. FIGS. 3D, 3E, and 3F represent chip structures used for sensing flow of gaseous liquids. They all share the Pt thin-film resistive heater 46 and sensing elements 47 and the silicon nitride passivation 48 of these elements, but differ in the size, shape and support of this high surface-to-volume sensing structure.

FIG. 3D shows a standard, front-etched off-the-shelf microbridge sensor structure 40, manufactured since 1987. FIG. 3E reveals a sealed, square micromembrane 51 of sensor structure 41 of about 750Πm (0.030″) on the side. Micromembrane 51 covers and seals open areas 49 shown in structure 40 to seal and prevent liquid or other substances from being lodged under the bridge supporting heater 46 and sensing elements 47 etched over open volume 50. FIG. 3F shows a similar version of sensor structure 41, except that micromembrane 51 is circular and of 500Πm (0.020″) in diameter. FIG. 3G reveals a polymer-filled volume 51 of structure 43, which is like structure 118, wherein the microbridge of heater 46, sensing elements 47 and volume 50, has become part of a solid and robust structure.

The use of ruggedized microsensor 43 via an epoxy fill reduces the effect of dust and droplets. The use of micromembrane 51 as compared to microbridge structure 40 eliminates the condensation problem (no recovery with the microbridge). The use of ruggedized structure 43 (FIG. 3G) increases the range of the sensor to higher flows.

All sensor chips mentioned above, and especially those shown in FIGS. 3B and 3C can be mounted on a TTW header featuring the reliability of an O-ring seal 22 such as is shown in FIG. 1. Said seal is positioned such that no external force is needed for maintaining a good seal.

Other embodiments of the invention, not disclosed here, do not minimize the spirit of the claimed invention.

What is claimed is:

1) A liquid flow microsensor comprising:
(a) a flow tube having a sensor aperture on the surface and having a straight-through conduit for fluid flow; and
(b) a sensor assembly mounted within the sensor aperture, wherein the sensor assembly includes a thermal sensor positioned to be within the straight-through conduit in direct communication with said fluid flow so as to sense thermal characteristics representative of a fluid flow rate.

2) The liquid flow microsensor of claim 1 further comprising at least a first flow screen mounted within said straight-through conduit upstream of the sensor and a second flow screen mounted within said straight-through conduit downstream of the sensor.

3) The liquid flow microsensor of claim 1 further comprising at least a first honeycomb flow straightener mounted within said straight-through conduit upstream of the sensor and a second honeycomb flow straightener mounted within said straight-through conduit downstream of the sensor.

4) The liquid flow microsensor of claim 1 wherein the straight-through conduit comprises a material selected from the group consisting of polymeric materials, nylon, polyimide, and Delrin®.

5) The liquid flow microsensor of claim 1 wherein the thermal sensor is so small that it has a response time of less than 1 second.

6) The liquid flow microsensor of claim 1 wherein the thermal sensor comprises an electrically insulating material.

7) The liquid flow microsensor of claim 1 wherein the thermal sensor has a semiconductor body comprising a material selected from the group consisting of ceramic, metal oxide, and glass.

8) The liquid flow microsensor of claim 1 wherein the thermal sensor has a sensing membrane supported by a solid, TCE-matched, porous, low thermal conductivity structure.

9) The liquid flow microsensor of claim 8 wherein the low thermal conductivity structure is comprised of material selected from the group consisting of high density lead oxide glass, silica gels, metal oxides and zeolites, glass composites and glass frits.

10) The liquid flow microsensor of claim 1 wherein the sensor assembly comprises a sensor header including internal conducting paths.

11) The liquid flow microsensor of claim 10 wherein the internal conducting paths comprise front-wire bonds (FWB).

12) The liquid flow microsensor of claim 10 wherein the internal conducting paths comprise through-the-wafer (TTW) contacts.

13) A liquid flow microsensor comprising:
(a) means for containing liquid flow having a sensor aperture on the surface and having a straight-through conduit for fluid flow; and
(b) a sensing means mounted within the sensor aperture, wherein the means for sensing includes a thermal sensor positioned to be within the straight-through conduit in direct communication with said fluid flow so as to sense thermal characteristics representative of a fluid flow rate; and
(c) at least first means for screening mounted within said straight-through conduit upstream of the means for sensing.

14) The liquid flow microsensor of claim 13 further comprising a second means for screening mounted within said straight-through conduit downstream of the sensor.

15) The liquid flow microsensor of claim 13 wherein the first means for screening comprises a first honeycomb screen mounted within said straight-through conduit upstream of the sensor, and the second means for screening comprises a second honeycomb screen mounted within said straight-through conduit downstream of the sensor.

16) The liquid flow microsensor of claim 13 wherein the thermal sensor comprises an electrically and thermally insulating material in a TO-18 configuration.

17) The liquid flow microsensor of claim 13 wherein the straight-through conduit comprises a material selected from the group consisting of polymeric materials, nylon, polyimide, and Delrin®.

18) The liquid flow microsensor of claim 13 wherein the thermal sensor has a semiconductor body comprising a material selected from the group consisting of ceramic, metal oxide, and glass.

19) The liquid flow microsensor of claim 13 wherein the thermal sensor has a response time of less than 1 second.

20) The liquid flow microsensor of claim 13 wherein the thermal sensor has a sensing membrane supported by a solid, TCE-matched, porous, low thermal conductivity structure.

21) The liquid flow microsensor of claim 13 wherein the low thermal conductivity structure is comprised of material selected from the group consisting of high density lead oxide glass, silica gels, metal oxides and zeolites, glass composites and glass frits.

22) A liquid flow microsensor comprising:
(a) a flow tube having a sensor aperture on the surface and having a straight-through conduit for fluid flow; and
(b) a sensor assembly mounted within the sensor aperture, wherein the sensor assembly includes a thermal sensor positioned to be within the straight-through conduit in direct communication with said fluid flow so as to sense thermal characteristics representative of a fluid flow rate;
(c) a first flow screen mounted within said straight-through conduit upstream of the sensor;
(d) a second flow screen mounted within said straight-through conduit downstream of the sensor; and
(e) wherein the sensor assembly comprises a sensor header including internal conducting paths.

23) The liquid flow microsensor of claim 22 wherein the internal conducting paths comprise front-wire bonds (FWB).

24) The liquid flow microsensor of claim 22 wherein the internal conducting paths comprise through-the-wafer (TTW) contacts.

25) The liquid flow microsensor of claim 10 wherein the sensor header comprises an integral O-ring groove.

26) The liquid flow microsensor of claim 22 wherein the sensor header comprises an integral O-ring groove.
